(19) United States
(12) Patent Application Publication
(10) Pub. No.: US 2021/0165509 A1
(43) Pub. Date: Jun. 3, 2021

(54) PRESSURE SENSORS AND NON-PLANAR SURFACES

(71) Applicant: Hewlett-Packard Development Company, L.P., Spring, TX (US)

(72) Inventor: Vinicius de Nardi Stock da Silva, Porto Alegre (BR)

(73) Assignee: Hewlett-Packard Development Company, L.P., Spring, TX (US)

(21) Appl. No.: 17/045,502

(22) PCT Filed: May 22, 2018
(86) PCT No.: PCT/US2018/033796

§ 371 Date: Oct. 6, 2020

(51) Int. Cl. G06F 3/038; G01L 1/22; G01L 5/1627

(52) U.S. Cl. CPC G06F 3/0383; G06F 2203/0384; G01L 5/1627; G01L 1/22

(57) ABSTRACT

Example implementations relate to pressure sensors and non-planar surfaces. For instance, in an example a system may include a non-planar surface and a plurality of pressure sensors coupled to respective portions of the non-planar surface to measure a location of a force applied to the respective portions of the non-planar surface and responsive to measuring the location of the force, output a signal to cause a cursor to move in a direction corresponding to the location of the force.

### BACKGROUND

A pointing device may be coupled to a computing device to control aspects of computing device. For instance, a pointing device may control a position of a cursor on a display of a computing device and/or otherwise facilitate interaction with the display of a computing device.

### BRIEF DESCRIPTION OF THE DRAWINGS

FIG. 1 illustrates a diagram of an example of a system according to the disclosure.

FIG. 2 illustrates an example of a pointing device according to the disclosure.

FIG. 3 illustrates a schematic view of an example of a pointing device according to the disclosure.

FIG. 4 illustrates a schematic view of another example of a pointing device according to the disclosure.

FIG. 5 illustrates a diagram of an example of a controller according to the disclosure.

### DETAILED DESCRIPTION

As mentioned, a pointing device may control a position of a cursor on a display of a computing device and/or otherwise facilitate interaction with the display of a computing device. For instance, a pointing device may be moved in a given direction by a user to cause a cursor on a display of a computing device to move in the same direction on the display. A user may also manipulate a pointing device with a finger to initiate right or left-click operations on a depressible button of the pointing device to allow the user to drag objects on the screen and/or select items on a display. Some pointing devices such as joysticks may be designed to be employed on a planar surface (i.e., a flat surface) such as on a desktop. As used herein, the term “planar” refers to surface with all vertices taken across a dimension of the object in the same plane (i.e., a flat non-curved surface). Some pointing devices may employ a planar force transducer located in and/or adjacent to a computing keyboard such as a keyboard in a laptop screen.

However, a portion of the population may experience difficulties moving a pointing device in given direction. For instance, senior citizens may have a decline in motor skills/fine muscle control and therefore may experience difficulties with moving a pointer device in a given direction. As a result, senior citizens or others may experience difficulty operating pointing devices such as those designed to be operated on flat surfaces and/or those employing a planar force transducer.

Accordingly, the present disclosure is directed to pressure sensors and non-planar surfaces. For example, a system may include a non-planar surface and a plurality of pressure sensors coupled to respective portions of the non-planar surface to measure a location of a force applied to the respective portions of the non-planar surface and responsive to measuring the location of the force, output a signal to cause a cursor to move in a direction corresponding to the location of the force. As used herein, the term “non-planar surface” refers to a surface with more than three vertices, and at least one of the vertices do not lie in the same plane, Examples of non-planar surfaces include curved surfaces and spherical surfaces, among other types of non-planar surfaces.

Notably, such non-planar surfaces may facilitate ergonomic pointing devices. For instance, pointer devices herein may be employed on either a planar surface (e.g., a desk) or on a non-planar surface (e.g., in a lap of the user). Additionally, pointer devices herein may permit application of a force at two distinct locations on the non-planar surface at the same time and/or permit two-handed operation, in contrast to other pointing devices such as those designed to be operated on flat surfaces and/or those that employ a planar force transducer.

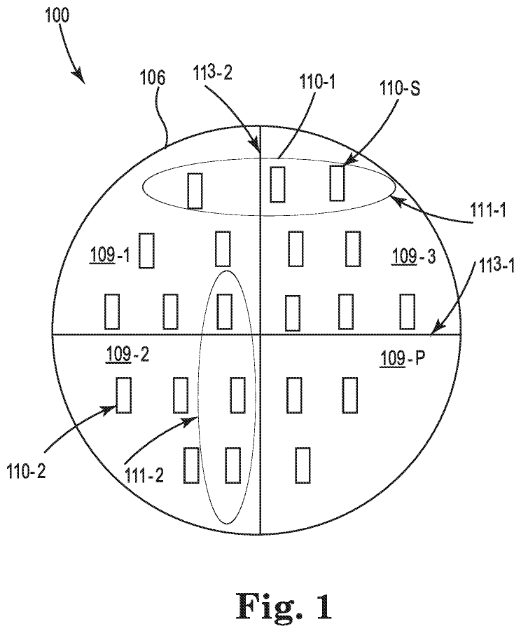

FIG. 1 illustrates a diagram of an example of a system 100 according to the disclosure. As illustrated in FIG. 1, the system 100 may include a non-planar surface 106 and a plurality of pressure sensors 110-1, . . . 110-S among other possible components including those described herein.

As mentioned, the term “non-planar surface” refers to a surface with more than three vertices and at least one of the vertices do not lie in the same plane. For instance, the non-planar surface 106 may be spherical as illustrated in FIG. 1. However, the disclosure is not so limited. Rather, the non-planar surface 106 may be a different shape. For instance, the non-planar surface 106 may be shaped as various other non-planar surfaces such as a prolate spheroid (i.e., a football), among other possibilities.

The non-planar surface 106 may be formed of a metal, plastic, fibers, or combinations thereof, among other possible materials. For instance, in some examples the non-planar surface may be formed of a metal such as aluminum, steel, titanium, or combinations thereof, among other types of metals. The non-planar surface 106 may be continuous, as illustrated in FIG. 1, or may include an opening such as a hole, slot, or other type of opening.

As used herein a pressure sensor refers to a device that has a capability to sense a pressure and converts the sensed pressure into an electric signal where a magnitude of the electrical signal depends upon an amount of the pressure applied. Examples of pressure sensors include strain gauges and/or piezoelectric films, among other types of pressure sensors. For instance, in some examples the pressure sensors 110-1, . . . 110-S may include strain gauges. For instance, in some examples each of the pressure sensors 110-1, . . . 110-S may be a respective strain gauge. That is, a user may move a pointer on a display screen by applying a force at a pressure sensor of the pressure sensors 110 with a finger and/or a palm. Responsive to application of such as force the pressure sensors 110 may measure a location of a force applied and/or an amount of the force applied.

The pressure sensors 110 may output a signal to cause a cursor to move in a direction corresponding to the location of the force, as detailed herein. For instance, the pressure sensors 110 may output a signal to cause a cursor to move in a direction corresponding to the location of the force responsive to measuring the location of the force and/or the amount of the force. That is, as illustrated in FIG. 1, the pressure sensors 110-1, . . . 110-S (collectively referred to as pressure sensors 110) may be coupled to respective portions 109-1, 109-2, 109-3, . . . , 109-P of the non-planar surface 106.

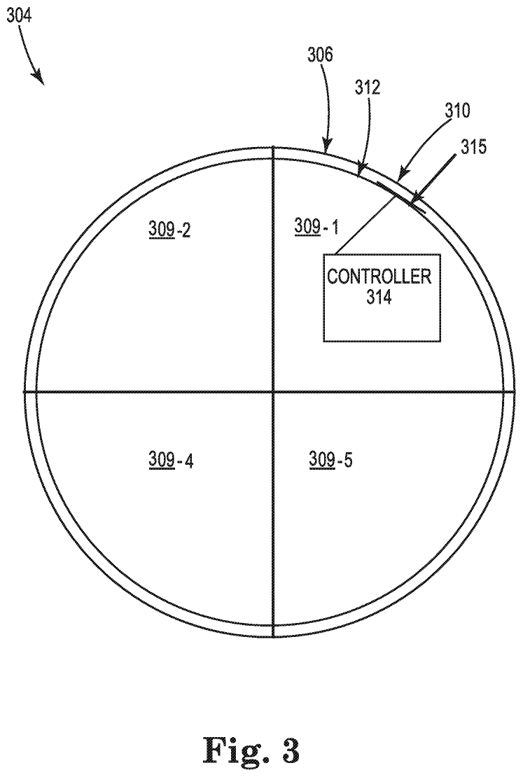

While FIG. 1 illustrates four total portions of the non-planar surface 106 it is understood that the total number of the portions may be increased or decreased depending upon an application of the non-planar device and/or a location/total number of pressure sensors, etc. Additionally, the non-planar surface 106 may include additional portions (e.g., portions 309-4 and 309-5 as described herein with respect to FIG. 3) that may not be visible from the view point of FIG. 1. In any case, determination of a location of a force such as a force applied to a portion (e.g., portion 109-1) via a pressure sensor (e.g., pressure sensor 110-2) a cursor may be caused to move in a direction (e.g., in a left direction on a display relative to a user viewing the display) corresponding to the location of the force and/or may cause an action to occur such as selection of an icon by the cursor or other type of action.

In some examples, the pressure sensors 110 may sense application of a force to at the two distinct locations. In such examples, an action may occur responsive to the force being applied at the two distinct locations. For instance, a force on a first portion 109-1 may result in first action (e.g., a cursor moving up on a display screen), a force on a second portion 109-2 may result in a second action (the cursor moving left on a display screen), while application of a force to both the first portion 109-1 and the second portion 109-2 may result in a third action (e.g., selection of a graphical icon at or near a location of the cursor), among other possible actions.

In various examples, the plurality of pressure sensors 110 on respective portions 109-1, . . . 109-P of the non-planar surface 106 may measure a location of a force applied in a direction substantially normal to the non-planar surface. As used herein, the term “direction substantially normal” refers to a direction that is orthogonal to a point on non-planar surface 106, as described herein with greater detail with respect to FIG. 3.

As illustrated in FIG. 1, in some examples the plurality of pressure sensors may include a first set 111-1 of pressure sensors (e.g., strain gauges) spaced substantially equidistant from adjacent pressure sensors in the first set substantially along a first axis 113-1. As used herein, the term “substantially” refers have to in this manner, a force applied to the non-planar surface 106 as a given location may be attributed to a pressure sensor located most proximate (e.g., registering a largest pressure signal) and thereby provide a location of the applied force in the first axis.

Similarly, in some examples the plurality of pressure sensors 110 may include a second set 111-2 of pressure sensors that are spaced substantially equidistant from adjacent pressure sensors (e.g., strain gauges) in the second set 111-2 substantially along a second axis 113-2. In this manner, a force applied to the non-planar surface 106 as a given location may be attributed to a pressure sensor located most proximate (e.g., registering a largest pressure signal) and thereby provide a location of the applied force in the first axis 113-1 and/or the second axis 113-2. That is, a location of a force may be determined by an individual pressure sensor or a plurality of pressure sensors, as described herein. It is noted that a total number of pressure sensors, a distance between adjacent pressure sensors in a set of pressure sensors, and/or a relative orientation between different sets of pressure sensors may be varied.

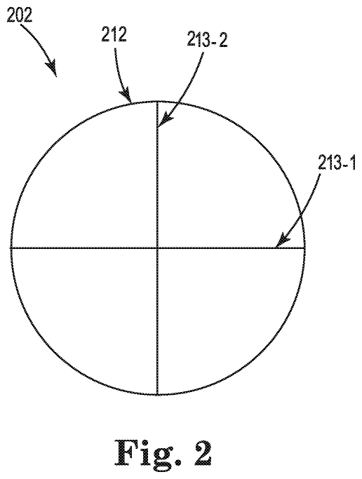

FIG. 2 illustrates a diagram of an example of a pointing device 202 according to the disclosure. The pointing device 202 may include a flexible material 212. The flexible material may include rubber, silicone rubber, and/or combinations thereof, among other possible materials.

As illustrated in FIG. 2, the flexible material 212 may overlay an entire surface area of the non-planar surface (not illustrated in FIG. 2). However, in some examples the flexible material may overlay a some but not all of, an entire surface area of the non-planar surface. For instance, in some examples the flexible material may overlay pressure sensors on the non-planar surface but may not overlay a portion of the flexible material that is without a pressure sensor, among other possibilities. For example, the flexible material may overlay a surface area of a subset of a portion (e.g., portion 109-1 as illustrated in FIG. 1) but may not overlay an entire surface area of the portion. In any case, as used herein the term “overlay” refers to covering another surface.

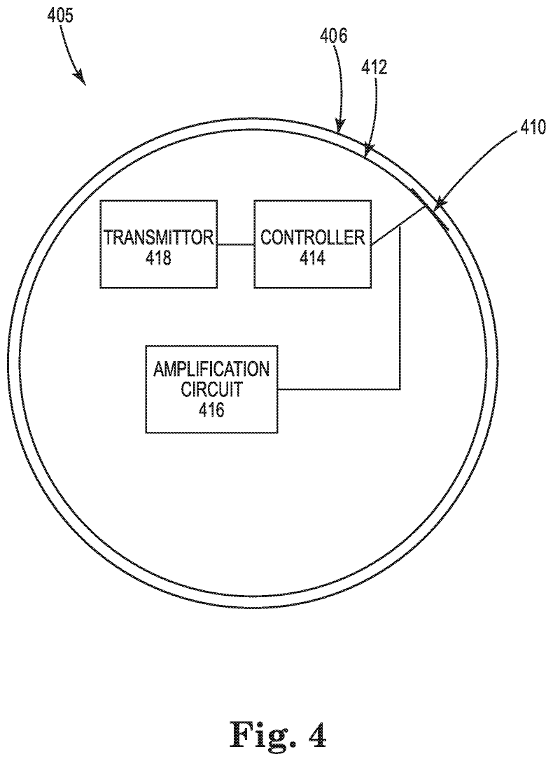

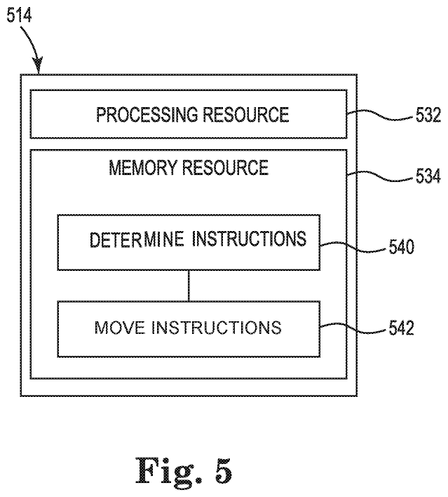

FIG. 3 illustrates a schematic view of an example of a cross-section of pointing device 304 according to the disclosure. As illustrated in FIG. 3, the pointing device may include a non-planar surface 306, a plurality of pressure sensors 310, a flexible material 312, and a controller 314, among other components including those described herein. The non-planar surface 306 may be analogous or similar to the non-planar surface 106 and/or 406 referenced in FIG. 1 and FIG. 4, respectively. The pressure sensors 310 may be analogous or similar to the pressure sensors 110 and/or 410 referenced in FIG. 1 and FIG. 4, respectively. The flexible material 312 may be analogous or similar to the flexible material 212 and/or 412 referenced in FIG. 2 and FIG. 4, respectively. The controller 314 may be analogous or similar to the controller 414 and/or 514 referenced in FIG. 4 and FIG. 5, respectively.

As illustrated in FIG. 3, in various examples the flexible material 312 may overlay a portion of the non-planar surface 306, and a plurality of pressure sensors 310 (represented as an individual pressure sensor 310 for ease of illustration). As illustrated in FIG. 3, the flexible material may directly overlay the non-planar surface and/or the pressure sensors 310 without an intervening element between the non-planar surface and/or the pressure sensors 310. However, the disclosure is not so limited. In some examples, an intervening element such as a barrier layer (e.g., a liquid/moisture, electrical, and/or mechanical barrier layer) may be present between the non-planar surface and the flexible material.

As mentioned, the pressure sensors 310 may be coupled to respective portions 309-1, 309-2, 309-4, 309-5 of the non-planar surface 312 to measure a location of a force 315 applied in a direction substantially normal to the non-planar surface. For instance, the force may be applied at a location of a pressure sensor or may be applied at a location adjacent to a pressure sensor. If a force is applied directly to a pressure sensor, the pressure sensor receiving the force may determine a location of the force as coinciding with a location of the pressure sensor.

If a force is applied indirectly to a pressure sensor (via deformation of the non-planar surface 306 and/or deformation of the flexible material 312 cause be the force), the pressure sensor may determine a location of the force as being adjacent to the pressure sensor. In this manner, if two or more pressure sensors experience a force at or near the same time the pressure sensors may be provide respective signal which may be employed to infer a location of the applied force.

For example, triangulation or other methodology may be used between adjacent pressure sensors to infer a location, an intensity, and/or a duration of an applied force. For instance, in some examples, the controller 314 may include instructions to measure an amount of force applied to two or more pressure sensors of the plurality of pressure sensors and infer a location of the applied force based on the respective forces applied to each pressure sensor of the two or more pressure sensors.

FIG. 4 illustrates another a schematic view of another example of a cross-section (taken along a first axis 213-2 of pointing device 202) pointing device 405 according to the disclosure. As illustrated in FIG. 4, a controller 414 may be disposed in an internal volume defined by the non-planar surface 406. Similarly, in some examples an amplification circuit 416 and/or a wireless transmitter 418 may be disposed in an internal volume defined by the non-planar surface 406. As used herein, “disposed” means a location at which something is physically positioned.

The amplification circuit 416 refers to device with a functionality to alter (e.g., increase) an electrical signal. For instance, the amplification circuit 416 may to increase a voltage and/or current of a signal of a force measured by a pressure sensor to form an amplified signal having a comparatively greater voltage and/or current than a signal measured by the pressure sensor. For example, the amplification circuit 416 may be coupled to a battery or other energy source (not illustrated) included in the pointing device 405 to power the amplification circuit and thereby alter an electrical signal provided from the pressure sensors 410 to the amplification circuit. Similarly, the pressure sensors 410 may be coupled to the battery or other energy source included in the pointing device to power the pressure sensors 410.

In various examples, the pointing device 405 may wireless output a signal. For instance, the pointing device 405 may include a digital to analog converter (DAC) and/or analog to digital converter to translate an amplified signal from the amplification circuit 416 to an output signal that may be output by the wireless transmitter 418, among other possibilities. Such translations may include translating the amplified signal into representative bits, among other possibilities.

The wireless transmitter 418 refers to a device with a functionality to wirelessly transmit a signal. For instance, the wireless transmitter 418 may transmit a signal representative of a measured location, intensity, and/or duration of a force applied to a pressure sensor 410 of the pointing device 405 and/or the transmitter may transmit a signal to cause a pointer to move on a display screen in a direction corresponding with the location, intensity, and/or the duration of the force. That is, the pointing device 405 may wirelessly transmit a signal indicative of an action such as selecting and/or moving a cursor on a screen. For instance, the transmitter may transmit a signal accordance with an 802.11 Institute of Electrical and Electronics Engineers protocol, a BLUETOOTH ® protocol, and/or a near-field communication (NFC) protocol, among other possibilities.

As illustrated in FIG. 4, the pointing device 405 may be free of depressible buttons. Stated differently, the pointing device 405 may be without a switch on the non-planar surface 406 or otherwise included in the pointing device 405. As used herein, the term “depressible button” refers to a switch which may be actuated from between an “on” or “off” state. Examples of depressible buttons include keycaps and manual switch having an “on” and “off” position. By having the pointing device 405 free of a depressible button a greater amount of surface area may be instrumented with pressure sensors such as those described herein and/or may provide a more ergonomic pointing device as compared to pointing devices that employ a depressible button.

FIG. 5 illustrates a diagram of an example of a controller 514 according to the disclosure. As illustrated in FIG. 5, the controller 514 may include a processing resource 532 and a non-transitory computer readable medium 534.

The processing resource 532 may be a central processing unit (CPU), a semiconductor based micro-processing resource, and/or other hardware devices suitable for retrieval and execution of computer-readable instructions such as those stored on the non-transitory computer readable medium 534.

The non-transitory computer readable medium 534 may be any electronic, magnetic, optical, or other physical storage device that stores executable instructions. Thus, non-transitory computer readable medium 534 may be, for example, Random Access Memory (RAM), an Electrically-Erasable Programmable Read-Only Memory (EEPROM), a storage drive, an optical disc, and the like.

The executable instructions may be “installed” on the controller 514 illustrated in FIG. 5. Non-transitory computer readable medium 534 may be a portable, external, or remote storage medium, for example, that allows the controller 514 to download the instructions from the portable/external/remote storage medium. In this situation, the executable instructions may be part of an “installation package”, As described herein, non-transitory computer readable medium 534 may be encoded with executable instructions related to pressure sensors and non-planar surfaces.

In various examples, the processing resource 532 may execute determine instructions 540 to receive a measured location of a force. For instance, the determine instructions 540 may include instructions to receive a measured location, magnitude, and/or a duration of a force measured by a pressure sensor such as those described herein. For instance, in some examples, the controller 514 may include instructions (not illustrated) to determine, via a pressure sensor, a location of a force applied to the respective portions of the non-planar surface.

In various examples, the processing resources 532 may execute move instructions 542 to output a signal to cause a cursor to move in a direction corresponding to the location of the force. For instance, the move instructions 542 may output a signal to cause a cursor to move in a direction corresponding to the location of the force responsive to receipt of the measured location of the force, among other possibilities.

In the foregoing detailed description of the disclosure, reference is made to the accompanying drawings that form a part hereof, and in which is shown by way of illustration how examples of the disclosure may be practiced. The figures herein follow a numbering convention in which the first digit corresponds to the drawing figure number and the remaining digits identify an element or component in the drawing. For example, reference numeral 106 may refer to element 106 in FIG. 1 and an analogous element may be identified by reference numeral 206 in FIG. 2. Elements shown in the various figures herein may be added, exchanged, and/or eliminated to provide additional examples of the disclosure. In addition, the proportion and the relative scale of the elements provided in the figures are intended to illustrate the examples of the disclosure and should not be taken in a limiting sense.

What is claimed:

1. A system comprising
a non-planar surface; and
a plurality of pressure sensors coupled to respective portions of the non-planar surface to:
measure a location of a force applied to a respective portion of the respective portions of the non-planar surface; and
responsive to measuring the location of the force, output a signal to cause a cursor to move in a direction corresponding to the location of the force.

2. The system of claim 1 further comprising a flexible material overlaying a portion of the non-planar surface.

3. The system of claim 2, wherein the flexible material overlays an entire surface area of the non-planar surface.

4. The system of claim 2, wherein in the flexible material includes rubber, silicone rubber, or combinations thereof.

5. The system of claim 1, wherein the plurality of pressure sensors includes a plurality of strain gauges.

6. The system of claim 5, wherein the plurality of strain gauges includes:
a first set of strain gauges spaced substantially equidistant from adjacent strain gauges in the first set along a first axis; and
a second set of strain gauges that are spaced substantially equidistant from adjacent strain gauges in the second set along a second axis.

7. The system of claim 1, wherein the non-planar surface is spherical.

8. A pointing device comprising:
a non-planar surface;
a flexible material overlaying a portion of the non-planar surface;
a plurality of strain gauges coupled to respective portions of the non-planar surface to measure a force applied in a direction substantially normal to the non-planar surface; and
a controller to:
receive the measurement of the force from a strain gauge of the plurality of strain gauges;
determine a location of the force based on location of the strain gauge; and
responsive to determination of the location of the force, output a signal to cause a cursor to move in a direction corresponding to the location of the force.

9. The pointing device of claim 8, further comprising an amplification circuit to amplify a signal of the measured force to form an amplified signal.

10. The pointing device of claim 8, further comprising a wireless transmitter.

11. The pointing device of claim 8, wherein the pointing device is free of depressible buttons.

12. A controller including:
a processing resource; and
a non-transitory computer readable medium storing instructions executable by the processing resource to:
determine, via a plurality of pressure sensors coupled to a non-planar surface, a location of force on a respective portion of the non-planar surface; and
responsive to determination of the location, cause a pointer to move on a display screen in a direction corresponding with the location of the force.

13. The controller of claim 13, wherein the location of the force is comprised of two distinct locations of force applied at the same time.

14. The controller of claim 14, further comprising instructions to cause an action to occur responsive to the force being applied at the two distinct locations.

15. The controller of claim 14, further comprising instructions to:
measure an amount of force applied substantially normal to two or more pressure sensors of the plurality of pressure sensors, and
infer a location of the applied force based on the respective forces applied to each pressure sensor of the two or more pressure sensors.
